(19) United States
(12) Patent Application Publication
(10) Pub. No.: US 2012/0278441 A1
(43) Pub. Date: Nov. 1, 2012

(54) System and Method for Quality of Experience Estimation

(75) Inventors: Zhu Li, Palatine, IL (US); Jun Tian, Belle Mead, NJ (US); Hong Heather Yu, West Windsor, NJ (US)

(73) Assignee: FutureWei Technologies, Inc., Plano, TX (US)

(21) Appl. No.: 13/096,427

(22) Filed: Apr. 28, 2011

(51) Int. Cl. G06F 15/16

(52) U.S. Cl. 709/219

(57) ABSTRACT

A system and method for quality of experience estimation are provided. A method for communications device operations includes selecting a portion of a media content stream, processing the portion to produce a processed portion, generating a signature from the processed portion, transmitting the signature, and transmitting the media content stream.

### TECHNICAL FIELD

The present invention relates generally to digital multimedia, and more particularly to a system and method for quality of experience estimation.

### BACKGROUND

A Content Delivery Network (CDN) may be used to deliver media content, such as movies, videos, music, images, multimedia, and so on, to one or more subscribers efficiently and cost effectively. Typically, the media as delivered to the subscriber may be configured by quality parameters in accordance to a subscription level of the subscriber. In many CDNs, a subscriber will pay for a particular subscription level. Usually, a higher subscription level will result in the media content being delivered with the quality parameters being set at a higher level. For example, at a highest level, the subscriber will pay the greatest subscription fees to ensure that they receive a guaranteed QoE level for the media content that they wish to receive, priority in receiving the media content, and so forth, while at a median level, the subscriber will pay a medium amount in subscription fees to ensure that they are guaranteed a medium QoE level, medium priority, and so forth. At a lowest level, the subscriber may not need to pay any subscription fees but may not be guaranteed any QoE level or even service. Examples of quality parameters may include media content device capability, media content bit-rate, codec bit-rate, frame size, frame rate, frame resolution, image size, image resolution, color depth, interlace or non-interlaced, additional features and materials (commonly referred to as “extras”), additional video and/or audio tracks, additional informative programming, subscriber subscription level, and so forth.

However, even if the media content is being delivered to the subscriber with the quality parameters set at a particular level, it may not be ensured that the subscriber will receive the media content and enjoy the media content at a user experience level commensurate to the setting of the quality parameters. As an example, subscriber may have selected a high-definition video to be delivered on a high-definition television, but due to high communications system traffic and sporadic errors, the communications system in unable to deliver sufficient bandwidth to deliver the high-definition video with an error rate low enough to yield an adequate user experience. Therefore, the subscriber may have a poor user experience.

A quality of experience (QoE) may be a metric that can be used to quantify the user experience of a subscriber. For example, if media content is received at a subscriber with little to no changes from when it was sent by a media content server, then the QoE should be high since the media content is received in a condition that was requested by the subscriber. However, if due to errors, congestion, or so forth, the media content is received at the subscriber with significant changes from when it was sent by the media content server, then the QoE should be moderate since the media content is received in a condition that is noticeably different from the condition that was requested by the subscriber. While, if due to extremely heavy errors, congestion, or so on, the media content is received at the subscriber in unacceptable condition, then the QoE should be poor since the media content is received in a condition that is significantly different from the condition that was requested by the subscriber.

However, QoE determination may be difficult to perform, especially when there are a large number of subscribers. In a typical CDN, there may be thousands to millions of subscribers. Determining QoE for each subscriber may require a dedication of a very large amount of computational and/or communications system resources. Furthermore, flexible management options for CDN operators may be desired.

### SUMMARY OF THE INVENTION

These and other problems are generally solved or circumvented, and technical advantages are generally achieved, by example embodiments of the present invention which provide a system and method for quality of experience (QoE) estimation.

In accordance with an example embodiment of the present invention, a method for communications device operations is provided. The method includes selecting a portion of a media content stream, processing the portion to produce a processed portion, generating a signature from the processed portion, transmitting the signature, and transmitting the media content stream.

In accordance with another example embodiment of the present invention, a communications device is provided. The communications device includes a portion selector, a signature unit coupled to the portion selector, and a transmitter coupled to the signature unit. The portion selector selects a portion of a media content stream, the signature unit processes the portion and generates a signature from the processed portion, and the transmitter transmits the signature and the media content stream.

In accordance with another example embodiment of the present invention, a method of communications device operations is provided. The method includes receiving a second media content stream, and receiving a first signature. The first signature is based on a first portion of a first media content stream. The method also includes selecting a second portion of the second media content stream. The second portion corresponds to the first portion of the first media content stream. The method further includes processing the second portion to produce a processed second portion, generating a second signature from the processed second portion, and generating a quality report from the first signature and the second signature.

In accordance with another example embodiment of the present invention, a communications device is provided. The communications device includes a receiver, a portion selector coupled to the receiver, a signature unit coupled to the portion selector, and a quality generator coupled to the signature unit. The receiver receives a second media stream and a first signature. The first signature is based on a first portion of a first media content stream. The portion selector selects a second portion of the second media stream. The second portion corresponds to the first portion of the first media content stream. The signature unit processes the second portion and generates a second signature from the processed second portion, and the quality generator generates a quality report based on the first signature and the second signature.

One advantage disclosed herein is that very small computational and/or communications system resources are required for QoE determination. Therefore, even for very large numbers of subscribers, small computation and/or communications system resources are needed.

A further advantage of exemplary embodiments is that QoE determination may be performed on an on-demand basis, allowing CDN operators to perform QoE determination when desired or needed, rather than at scheduled or periodic intervals.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example communications system 100 configured to deliver media content to subscribers according to example embodiments described herein;

FIG. 2 illustrates an example detailed view of a communications system 200 configured to deliver media content F to subscribers, wherein a signature based QoE determination is used to provide low overhead and high management flexibility operation according to example embodiments described herein;

FIG. 3 illustrates an example flow diagram of participant operations 300 for sending media content to subscribers, wherein a signature based QoE determination is used to provide low overhead and high management flexibility operation according to example embodiments described herein;

FIG. 4 illustrates an example flow diagram of participant operations 400 in generating a signature from media content according to example embodiments described herein;

FIG. 5 illustrates an example flow diagram of participant operations 500 in determining a QoE label, wherein a signature based QoE determination is used to provide low overhead and high management flexibility operation according to example embodiments described herein;

FIG. 6 illustrates an example flow diagram of participant operations 600 in determining a QoE value (or QoE label) according to example embodiments described herein;

FIG. 7 illustrates an example communications device according to example embodiments described herein; and

FIG. 8 illustrates an example communications device according to example embodiments described herein.

### DETAILED DESCRIPTION OF ILLUSTRATIVE EMBODIMENTS

The making and using of the current example embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to example embodiments in a specific context, namely a CDN that makes use of QoE determination to determine if performance requirements are being met. The invention may also be applied, however, to other communications systems where an on-demand metric may be used to determine communications system performance.

Many related art techniques exist for QoE determination, including Video Quality Metric (VQM), Moving Pictures Quality Metric (MPQM), Structural Similarity (SSIM) Index, and so forth. However, the prior art techniques require the original video and/or image for determining the QoE. Transmitting (especially broadcasting) the original video and/or image may be cost (in terms of communications system resources, for example) prohibitive. Therefore, there is a need for a low-cost technique for QoE determination with flexible management options.

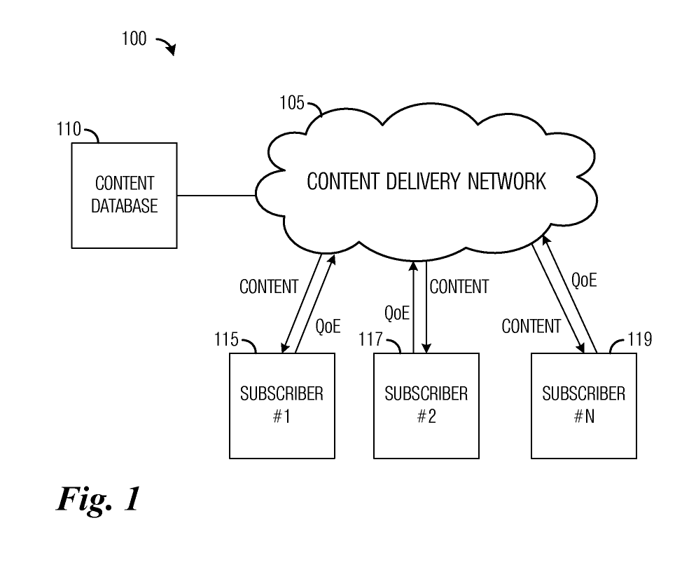

FIG. 1 illustrates a communications system 100 configured to deliver media content to subscribers. Communications system 100, being configured to deliver media content to subscribers (potentially along with other functions, such as voice and/or data), includes a CDN 105 that may be specially designed for efficient and cost effective delivery of media content provided by a content database 110 to a number of subscribers, such as subscriber #1 115, subscriber #2 117, and subscriber #N 119.

Responding to a media content request from a subscriber, CDN 105 may deliver a media content alternative selected by the subscriber and/or a media content server and in accordance with a subscription level of the subscriber to the subscriber. In general, the media content may be precoded or pre-configured in to a number of media content alternatives at differing levels of quality, features, bit-rates, and so forth. Then, the subscriber may select a media content alternative commensurate with its own subscription level, device capabilities, and so forth. The media content alternative may be selected based on quality parameters, such as media content device capability, media content bit-rate, codec bit-rate, frame size, frame rate, frame resolution, image size, image resolution, color depth, interlace or non-interlaced, additional features and materials (commonly referred to as “extras”), additional video and/or audio tracks, additional informative programming, subscriber subscription level, and so forth.

The subscriber may determine a QoE value that may be reported back to the media content server, the QoE value may be an indication of an overall quality of the media content received by the subscriber. According to an example embodiment, the QoE value may be based on the media content prior to being delivered by CDN 105 as well as the media content as received by the subscriber.

The media content server may then make use of the QoE value to adjust media content being sent to the subscriber. As an example, if the QoE value indicates that the subscriber is not experiencing a QoE congruent to the subscriber's subscription level, the media content server may attempt to utilize a different route to the subscriber, wherein the different route has less congestion and/or errors.

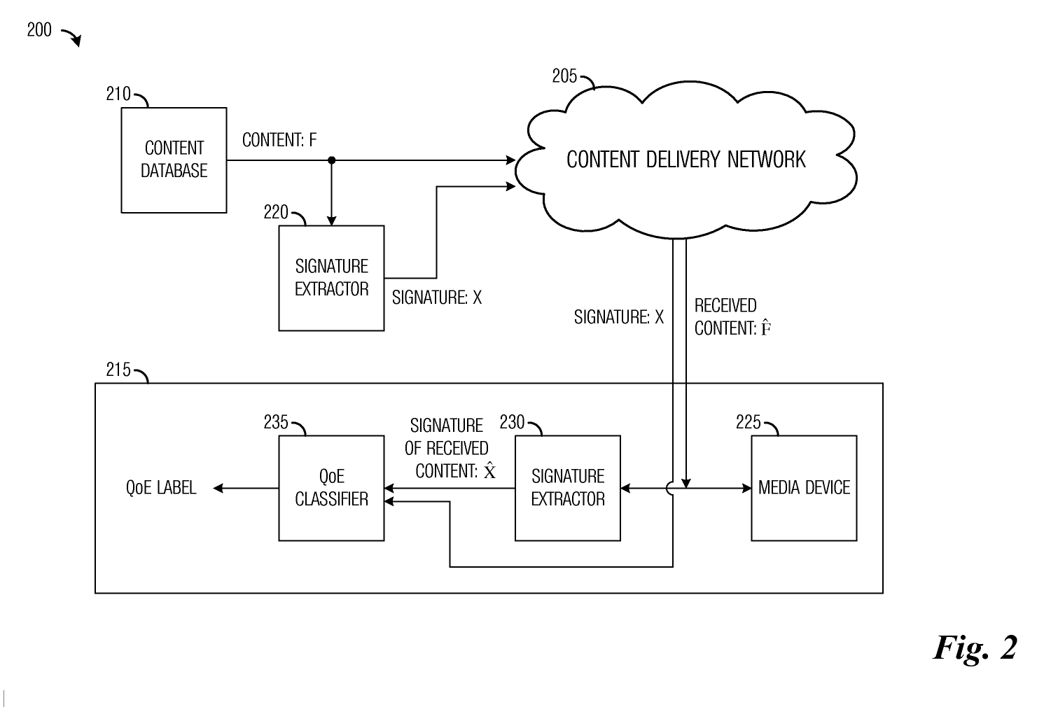

FIG. 2 illustrates a detailed view of a communications system 200 configured to deliver media content F to subscribers, wherein a signature based QoE determination is used to provide low overhead and high management flexibility operation. Communications system 200, being configured to deliver media content to subscribers (potentially along with other functions, such as voice and/or data), includes a CDN 205 that may be specially designed for efficient and cost effective delivery of media content provided by a content database 210 to a subscriber 215. Although communications system 200 is shown as serving a single subscriber, in practice, communications system 200 may serve a very large number of subscribers.

For discussion purposes, consider a situation wherein the media content being sent to subscriber 215 is a video comprising a number of video frames. However, media content may be another type of media, such as images, music, multimedia, movies, and so on. Therefore, the discussion being focused on video should not be construed as being limiting to either the scope or the spirit of the example embodiments.

According to an example embodiment, communications system 200 makes use of a signature based QoE determination technique to provide low overhead and high management flexibility operation. At a source end of a media content delivery path, which comprises a media content source (e.g., content database 210), a delivery network (e.g., CDN 205), and a media content destination (e.g., subscriber 215), a signature extractor 220 may be used to generate a signature X for the media content being sent to subscriber 215.

According to an example embodiment, the signature X may be generated from a single frame and/or image from the video. The signature X may be generated from the frame using a transformation that produces an output that is smaller than the frame. As an example, the transform may be a wavelet filterbank decomposition function, a singular value decomposition function, a discrete cosine transform function, and so forth. According to an example embodiment, the signature X may be the output of the transformation, a portion of the output of the transformation, a function of the output of the transformation, or so on. As an example, a portion (a statistically significant portion, for example) of the output of the transformation may be used as the signature X and a remainder of the output of the transformation (which may be statistically insignificant) may be discarded.

According to an example embodiment, the signature X may be generated from an entirety of the frame. However, the frame may also be scaled down and/or otherwise processed prior to being provided to the transformation to generate the signature X. As an example, the processing of the image may reduce the bit-depth of the image, the color depth of the image, a dimension(s) of the image, quantizing the image, compressing the image, or so on. The scaling and/or processing of the image may help to reduce the computational and/or communications system load involved in generating and transmitting the signature X by reducing size and/or complexity of the image prior to generating the signature X. For example, the image may be scaled and/or processed until it is much smaller than it was originally, such as on the order of about 5 to 20 percent of its original size.

The media content F and the signature X may then be sent to subscriber 215 over CDN 205. Due to transmission errors and/or noise, subscriber 215 may receive media content \hat{F} rather than media content F, where media content \hat{F} is the media content F with errors and/or noise due to transmission. Although media content F may be assumed to have transmission errors and/or noise, signature X is assumed to have been received error free. Error free reception of signature X may be a reasonable assumption due to the relative small size of signature X. Furthermore, if error free reception of signature X is not possible, signature X may be encoded with an error detection and correction code to help ensure error free reception.

The media content \hat{F} may then be sent to a media device 225 of subscriber 215. As an example, considering the example wherein the media content is a video, media device 225 may be a television, a computer, a smart telephone, a digital video recorder, or so forth.

The media content \hat{F} may also be provided to a signature extractor 230 that may utilize a transformation to generate a signature k from the media content \hat{F}. According to an example embodiment, the transformation used at signature extractor 230 may be the same as the transformation used at signature extractor 220. Furthermore, if the media content F was scaled or otherwise processed prior to signature generation at signature extractor 220, then media content \hat{F} may also be similarly scaled or processed.

The signature X and the signature \hat{X} may then be provided to a QoE classifier 235 to generate a QoE value (or similarly, a QoE label) in accordance with the signature X and the signature \hat{X}. According to an example embodiment, QoE classifier 235 may be implemented using a classification function that can be trained and/or pre-determined off-line (a priori) and stored in or near QoE classifier 235 or subscriber 215. Examples of classification functions may include Kernel Gaussian Mixture (KGM) models, Canonical Correlation Analysis (CCA) models, and so forth.

As an example, output of QoE classifier 235 may be a QoE value (or QoE label) that may be a multi-level value, such as Excellent, Good, Fair, and Poor. Although output of QoE classifier 235 is shown in the above example as being a four-valued value, any number of values may be supported, depending on desired QoE resolution, desired or supportable computational and/or communications system load, desired classification function complexity, and so on.

The QoE value may be provided back to the media content source (such as a media server) in the form of a QoE report, where it may be used to adjust the media content and/or its delivery route to improve the QoE value if needed. As an example, the media content's bit-rate, frame size, image resolution, image bit-depth, and so forth may be altered in accordance with the QoE value. Alternatively, an alternate route, which may be less congested or less error prone (or more congest or more error prone), may be selected to deliver the media content to subscriber 215.

Although the discussion focuses on the QoE determination (i.e., signature extractor 230 and QoE classifier 235) occurring in subscriber 215, QoE determination may occur at any point in the media content delivery path. As an example, QoE determination may occur at edge servers located in CDN 205, routers in CDN 205, or other network entities between CDN 205 and subscriber 215.

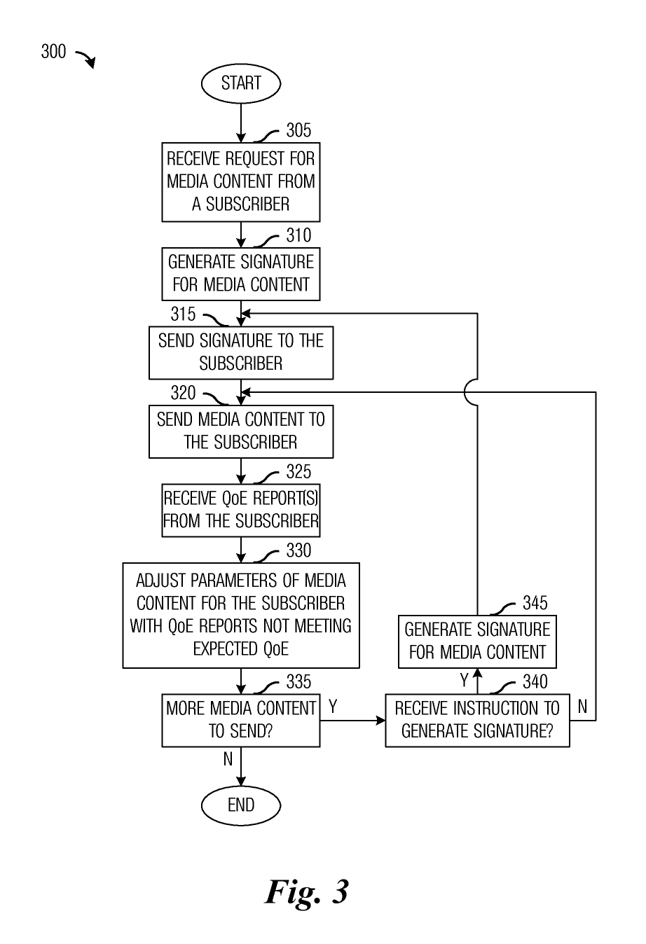

FIG. 3 illustrates a flow diagram of participant operations 300 for sending media content to subscribers, wherein a signature based QoE determination is used to provide low overhead and high management flexibility operation. Participant operations 300 may be indicative of operations occurring in a media server (or some other controller or network entity) responsible for responding to media content requests and serving the requested media content to a subscriber making the request. Alternatively, participant operations 300 may be indicative of operations occurring in a network entity located in the media content delivery path that is interested in measuring QoE of subscribers. For example, participant operations 300 may occur at a router, communications controller, or so on, in the media content delivery path. Participant operations 300 may occur while the participant is in a normal operating mode and has a subscriber to serve.

The discussion of participant operations 300 focuses on a media server being the participant. However, participant operations 300 may occur at a variety of network entities located along the media content delivery path with relatively minor modifications to participant operations 300 that are considered to be obvious to those of ordinary skill in the art of the example embodiments. For example, if participant operations 300 is occurring at a communications controller in the media content delivery path, the communications controller may not need to receive and/or respond to a request for media content from a subscriber. Therefore, the focus on the media server should not be construed as being limiting to either the scope or the spirit of the example embodiments.

Participant operations 300 may begin with a media server receiving a request for media content F from a subscriber (block 305). According to an example embodiment, the media content request may include a selection of a media content alternative made by the subscriber. Alternatively, the media content request may include a specification of the media content and the media server may select a media content alternative for the subscriber, wherein the selection may be based on the subscriber's subscription level, communications system load, available communications system bandwidth, media server load, and so on.

The media server may generate a signature X for the media content F, e.g., the media content alternative selected by the subscriber or a media content alternative selected by the media server (block 310). According to an example embodiment, the media server may generate the signature X using a signature extractor, such as signature extractor 220. According to an example embodiment, the media server may select a single image from a video from which to generate the signature X. According to another example embodiment, the media server may select a reference image from a video for each group of pictures (GoP) from which to generate the signature X, therefore, the video may result in a plurality of signatures X.

The media server may send the signature X to the subscriber (block 315). According to an example embodiment, the media server also sends an indication of which frame in the media content F was used to generate the signature X. For example, the media server may include a timing reference.

The media server may send the media content F to the subscriber (block 320).

The media server may receive a QoE report from the subscriber (block 325). According to an example embodiment, the media server may receive a QoE report from the subscriber for each signature X sent to the subscriber, wherein the QoE report comprises an indication of the quality of the media content received by the subscriber, and wherein the subscriber makes use of the signature X to help determine the quality of the media content. The subscriber may generate a signature \hat{X} from media content \hat{F} and then generate a QoE value (or a QoE label) from the signature X and the signature \hat{X} when it receives a single image corresponding to the single image used by the media server to generate the signature X or a reference image from a GoP corresponding to the reference image used by the media server to generate the signature X.

The media server may adjust quality parameters of the media content being delivered to the subscriber based on the QoE report (block 330). Typically, adjusting the quality parameters may involve low overhead operations such as selecting a different media content alternative, selecting a different transmission path (route) to the subscriber, and so forth, to try to improve the QoE of the subscriber. As an example, selecting a lower quality media content alternative may also reduce transmission errors which may result in a better QoE value for the media content. Similarly, selecting a different transmission path may result in fewer (or greater) transmission errors due to lower (or higher) contention and so on.

Generally, the media server may adjust the quality parameters to increase the subscriber's QoE value. However, the media server may adjust the quality parameters to decrease the subscriber's QoE value if the QoE report from the subscriber reports a QoE value that is greater than the subscriber's subscription level while other subscribers are reporting QoE values that are lower than their subscription levels. In such a situation, the media server may select a media content alternative corresponding to lower quality parameters, select a different transmission path to the subscriber wherein the different transmission path is more loaded or error prone, even elect to stop media content delivery to a subscriber at the lowest subscription level to improve the QoE value of higher subscription level subscribers, and so on.

According to an example embodiment, the media server may elect to wait for several consecutive QoE reports from the subscriber before adjusting the quality parameters. By waiting for several consecutive QoE reports, transient fluctuations in QoE values based on dynamic communications system conditions that may result in a ping-pong effect may be avoided. The number of consecutive QoE reports may be dependent on how frequent the QoE reports are received, specified responsiveness to the QoE reports, variance in the QoE reports, and so on.

The media server may perform a check to determine if there is more media content to send, i.e., are there more media content requests or unfinished media content requests (block 335). If there is no more media content to send, then the participant operations 300 may terminate.

If there is more media content to send, then the media server may perform a check to determine if it has received an instruction and/or a request to generate a signature X (block 340). Responding to an instruction and/or a request to generate a signature X from the media content F may enable an on-demand form of operation which may help to reduce computational and/or communications system load when resources are scarce, for example. Rather than an explicit instruction to the media server to generate a signature X, the media server may be configured to generate a signature X at specified time intervals or time events.

If the media server has received an instruction and/or a request to generate a signature X, then the media server may generate the signature X from the media content F (block 345). After generating the signature X in block 345, the media server may return to block 315 to send the signature X to the subscriber.

If the media server has not received an instruction to generate a signature in block 340, the media server may return to block 320 to continue to send more media content to the subscriber.

Participant operations 300 is described as an illustrative embodiment of media server operations in sending media content to subscribers. Participant operations 300 may be modified to obtain other illustrative embodiments. For example, participant operations 300 may be modified so that a signature X is generated for the media content and sent to the subscribers without having to receive an instruction to generate a signature X, therefore a single signature X may be generated and sent to the subscriber. Alternatively, participant operations 300 may be modified so that a signature X is generated for the media content and sent to the subscribers at specified times and/or with a specified periodicity. Alternatively, participant operations 300 may be modified so that a signature X is not generated or sent to the subscribers until an instruction to generate a signature is received, therefore a signature X is not generated or sent to the subscribers until it is requested.

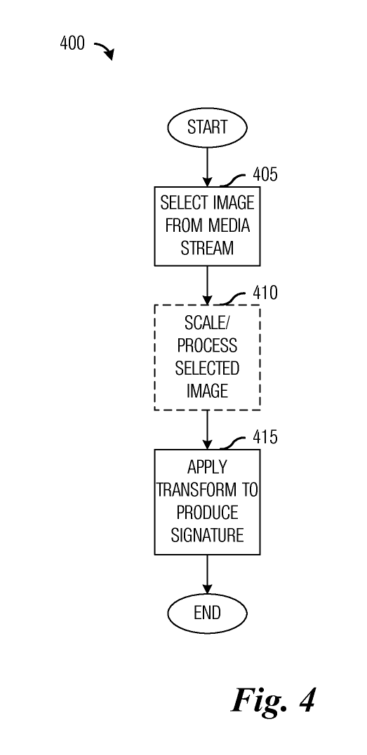

FIG. 4 illustrates a flow diagram of participant operations 400 in generating a signature from media content. Participant operations 400 may be indicative of operations occurring in a media server, a subscriber, or any other network entity (referred to herein as participant) participating in the sending and/or receiving of media content. Participant operations 400 may occur while the participant is in a normal operating mode.

For discussion purposes, consider a situation wherein the media content being a video. However, media content may be another type of media, such as images, music, multimedia, movies, and so on. Therefore, the discussion being focused on video should not be construed as being limiting to either the scope or the spirit of the example embodiments.

Participant operations 400 may begin with the participant selecting an image from the media stream from which the signature will be generated (block 405). According to an example embodiment, the participant may arbitrarily select the image from the media stream. According to an example embodiment, the participant may select a reference frame from a GoP.

In order to help reduce computational and/or communications system load, the participant may optionally scale and/or process the image (block 410). As an example, the processing of the image may reduce the bit-depth of the image, the color depth of the image, or so on. Scaling and/or processing of the image may help to reduce the computational and/or communications system load involved in generating and subsequently transmitting the signature by reducing the size and/or complexity of the image prior to generating the signature.

The participant may apply a transform to the image or a scaled and/or processed version of the image to produce the signature (block 415). As an example, the transform may be a wavelet filterbank decomposition function, a singular value decomposition function, a discrete cosine transform function, and so forth. According to an example embodiment, the signature X may be the output of the transformation, a portion of the output of the transformation, a function of the output of the transformation, or so on. As an example, a portion of the output of the transformation may be used as the signature X and a remainder of the output of the transformation (which may be statistically insignificant) may be discarded.

Consider an illustrative example of signature generation presented herein. A signature may be generated by sampling chosen intra-frames from a video sequence, wherein the chosen intra-frames may have been reduced to thumbnail (i.e., smaller representations of the intra-frames) of dimension width by height (w by h) and projected onto a subspace of desired dimension d. The signature X may then be expressed as

X_{mxd}=F_{mxD}A_{Dxd},

where X is a m by D icon image matrix with m rows of icon image vectors of dimension D=w by h, A is a pre-trained subspace model matrix of dimension D by d that offers maximum information preserving projection for icon images to a desired d-dimensional space, and F is the thumbnail matrix of the intra-frames with dimension m by D. A choice of random sample time stamp and number of frames m may affect the performance of QoE generation accuracy. Generally, larger values of m provide greater accuracy with greater incurred computational load. As an example, for a 30 frame per second, 15 frame GoP structure, a compact signature representation of 2d bytes per second is achievable. Therefore, for a typical d=16, the signature requires only 32 bytes per second.

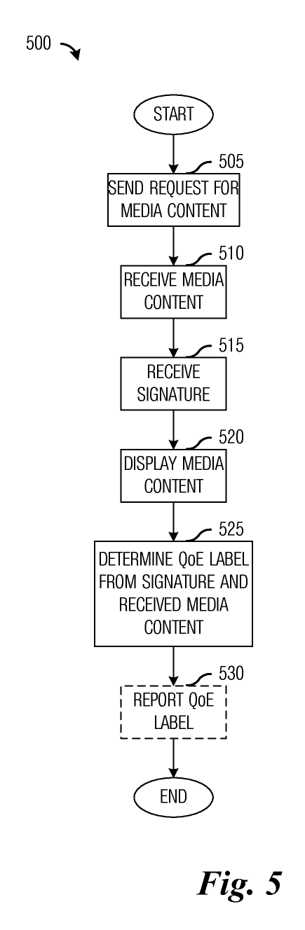

FIG. 5 illustrates a flow diagram of participant operations 500 in determining a QoE label, wherein a signature based QoE determination is used to provide low overhead and high management flexibility operation. Participant operations 500 may be indicative of operations occurring in a subscriber or any other network entity (referred to herein as participant) participating in the sending and/or receiving of media content. Participant operations 500 may occur while the participant is in a normal operating mode.

For discussion purposes, consider a situation wherein the media content being a video. However, media content may be another type of media, such as images, music, multimedia, movies, and so on. Therefore, the discussion being focused on video should not be construed as being limiting to either the scope or the spirit of the example embodiments.

The discussion of participant operations 500 focuses on a subscriber being the participant. However, participant operations 500 may occur at a variety of network entities located along the media content delivery path with relatively minor modifications to participant operations 500 that are considered to be obvious to those of ordinary skill in the art of the example embodiments. For example, if participant operations 500 is occurring at a communications controller in the media content delivery path, the communications controller may not need to generate a request for media content and send the request to the media server. Therefore, the focus on the subscriber should not be construed as being limiting to either the scope or the spirit of the example embodiments.

Participant operations 500 may begin with a subscriber generating and sending a request for media content to a media server (block 505). According to an example embodiment, the request for media content may include a selection of a media content alternative selected by the subscriber based factors such as the subscriber's subscription level, capabilities of the subscriber's equipment to be used to process (e.g., display, play, save, and so forth) the media content, capabilities of the subscriber's connection to the media server, and so on.

As a result of the request for media content, the subscriber may receive media content \hat{F} (which is the requested media content with possible transmission errors and noise) from the media server (block 510). The subscriber may also receive one or more signatures X corresponding to one or more selected frames in the video from the media server (block 515).

The subscriber may display, save, or so on, the received media content \hat{F} (block 520).

The subscriber may also determine a QoE value (or QoE label) for the received media content \hat{F} using the received signature X and a signature \hat{X} that the subscriber generates on its own using the received media content \hat{F} (block 525). According to an example embodiment, the QoE value may be generated from the received signature X and the signature \hat{X} through the use of a classification function that can be trained and/or pre-determined off-line and stored in or near the subscriber. Examples of classification functions may include Kernel Gaussian Mixture (KGM) models, Canonical Correlation Analysis (CCA) models, and so forth.

The subscriber may optionally report the QoE value (or QoE label) to the media server (block 530).

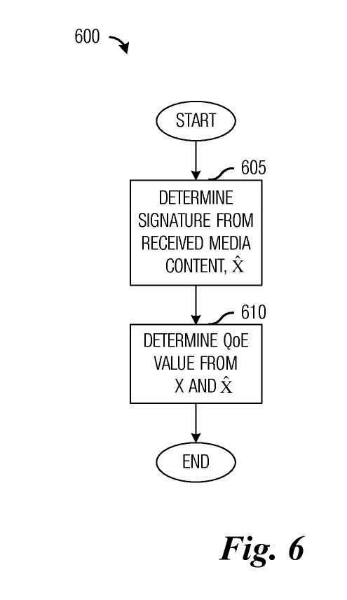

FIG. 6 illustrates a flow diagram of participant operations 600 in determining a QoE value (or QoE label). Participant operations 600 may be indicative of operations occurring in a subscriber or any other network entity (referred to herein as participant) participating in the sending and/or receiving of media content. Participant operations 600 may occur while the participant is in a normal operating mode.

For discussion purposes, consider a situation wherein the media content being a video. However, media content may be another type of media, such as images, music, multimedia, movies, and so on. Therefore, the discussion being focused on video should not be construed as being limiting to either the scope or the spirit of the example embodiments.

Participant operations 600 may begin with the participant determining a signature \hat{X} from received media content \hat{F}, which corresponds to media content F sent by a media server, but may include transmission errors and/or noise (block 605). According to an example embodiment, the participant may make use of a signature extractor, such as signature extractor 230, to generate the signature \hat{X}. According to an example embodiment, the participant may need to generate the signature \hat{X} on a frame of the received media content \hat{F} that corresponds to a frame of the media content F that was used to generate the signature X. To assist the participant in determining which frame to use, the media server may provide information to help in identifying the frame.

The participant may determine the QoE value from the signature X and the signature \hat{X} (block 610). According to an example embodiment, the QoE value may be generated from the received signature X and the signature \hat{X} through the use of a classification function that can be trained and/or pre-determined off-line and stored in or near the participant. Examples of classification functions may include Kernel Gaussian Mixture (KGM) models, Canonical Correlation Analysis (CCA) models, and so forth.

Consider an illustrative example of training a classification function with a video presented herein. A number of original video frames N, for example, a large number of approximately 2000 frames, may be selected. Simulated distortion of the original video frames at a variety of levels (for example, four levels, such as Excellent, Good, Fair, and Ugly) may be generated. Then, for each original video frame Fₖ, a signature Xₖ may be generated. Similarly, for each simulated distorted video frame at distortion level 1, a signature \hat{X}_{k,l} may be generated. The signatures Xₖ and \hat{X}_{k,l} form a training data set.

For each coded video frame with distortion level 1, a training differential vector may be obtained. The training differential vector is expressible as

Z_{k,l}(\hat{X}_{k,l}−Xₖ),

where Z_{k,l} is the training differential vector for original video frame k and distortion level 1.

The training differential vector may be provided to a machine learning algorithm, such as a KGM or a CCA, to obtain the QoE value (or QoE label).

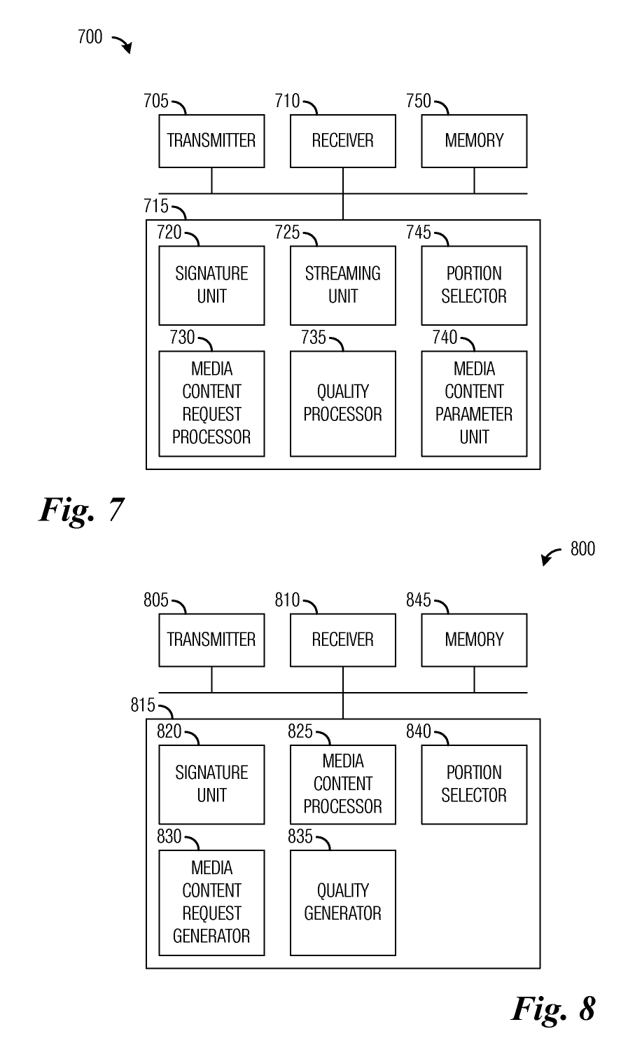

FIG. 7 provides an alternate illustration of a communications device 700. Communications device 700 may be used to implement various ones of the embodiments discussed herein. As shown in FIG. 7, a transmitter 705 is configured to transmit information and a receiver 710 is configured to receive information.

A signature unit 720 is configured to generate a signature from an image (or some other media content). Signature unit 720 may scale and/or provide processing to the image prior to generating the signature. A streaming unit 725 is configured to prepare media content for streaming. A media content request processor 730 is configured to process requests for media content, such as media content alternative selection, and so on. A QoE processor 735 is configured to make adjustments (such as media content selection, transmission path selection, transcoding, and so forth) based on reported QoE values, subscriber subscription levels, communications system condition, and so forth. QoE processor 735 is further configured to initiate the generation of a signature based on a receipt of an instruction to generate a signature, periodically, or at specified intervals. A media content parameter unit 740 is configured to process media content parameters, for example, based on subscriber subscription levels, communications system condition, and so on. A portion selector 745 is configured to select a portion of a media content stream, such as an image, from which to generate the signature. Portion selector 745 is also configured to produce an indicator that is used to locate the portion in the media content stream. A memory 750 is configured to store media content, signatures, requests for media content, media content parameters, etc.

The elements of communications device 700 may be implemented as specific hardware logic blocks. In an alternative, the elements of communications device 700 may be implemented as software executing in a processor, controller, application specific integrated circuit, or so on. In yet another alternative, the elements of communications device 700 may be implemented as a combination of software and/or hardware.

As an example, receiver 710 and transmitter 705 may be implemented as a specific hardware block, while signature unit 720, streaming unit 725, media content request processor 730, QoE processor 735, media content parameter unit 740, and portion selector 745 may be software modules executing in a microprocessor (such as processor 715) or a custom circuit or a custom compiled logic array of a field programmable logic array.

FIG. 8 provides an alternate illustration of a communications device 800. Communications device 800 may be used to implement various ones of the embodiments discussed herein. As shown in FIG. 8, a transmitter 805 is configured to transmit information and a receiver 810 is configured to receive information.

A signature unit 820 is configured to generate a signature from a received image (or some other received media content). Signature unit 720 may scale and/or provide processing to the received image prior to generating the signature. A media content processor 825 is configured to process, such as display, play, store, forward, or so on, the received media content. A media content request generator 830 is configured to generate requests for media content. The request may be based on factors such as subscriber subscription level, communications system condition, subscriber processing capabilities, subscriber display capabilities, and so forth. A quality generator 835 is configured to generate a QoE value (or QoE label) based on received signatures, the received media content, signatures generated from the received media content, and so forth, using a classification system. A portion selector 840 is configured to select a portion of a media content stream, such as an image, from which to generate the signature. Portion selector 840 may select the portion based on an indication of a location of a corresponding portion used to generate a signature at a source of the media content stream. A memory 845 is configured to store signatures, media content, requests for media content, QoE values, etc.

The elements of communications device 800 may be implemented as specific hardware logic blocks. In an alternative, the elements of communications device 800 may be implemented as software executing in a processor, controller, application specific integrated circuit, or so on. In yet another alternative, the elements of communications device 800 may be implemented as a combination of software and/or hardware.

As an example, receiver 810 and transmitter 805 may be implemented as a specific hardware block, while signature unit 820, media content processor 825, media content request generator 830, quality generator 835, and portion selector 840 may be software modules executing in a microprocessor (such as processor 815) or a custom circuit or a custom compiled logic array of a field programmable logic array.

The above described embodiments of communications system 200, communications device 700, and communications device 800 may also be illustrated in terms of methods comprising functional steps and/or non-functional acts. The previous description and related flow diagrams illustrate steps and/or acts that may be performed in practicing example embodiments of the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use (or non use) of steps and/or acts in the recitation of the claims—and in the description of the flow diagrams(s) for FIGS. 3, 4, 5, and 6—is used to indicate the desired specific use (or non-use) of such terms.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for communications device operations, the method comprising:
selecting a portion of a media content stream;
processing the portion to produce a processed portion;
generating a signature from the processed portion;
transmitting the signature; and
transmitting the media content stream.

2. The method of claim 1, wherein processing the portion comprises scaling the portion.

3. The method of claim 1, wherein processing the portion comprises reducing a bit-depth of the portion, reducing a color depth of the portion, reducing a dimension of the portion, compressing the portion, or combinations thereof.

4. The method of claim 1, wherein generating a signature comprises providing the processed portion to a transformation function.

5. The method of claim 4, wherein the transformation function comprises a wavelet filterbank decomposition function, a singular value decomposition function, a discrete cosine transform function, or combinations thereof.

6. The method of claim 4, wherein the transformation function produces an output, and wherein the signature comprises a portion of the output.

7. The method of claim 6, wherein the signature comprises a statistically significant portion of the output.

8. The method of claim 1, wherein the selecting, the processing, the generating, and the transmitting the signature are performed in response to receiving an instruction to generate a signature.

9. The method of claim 1, wherein the selecting, the processing, the generating, and the transmitting the signature are performed at specified intervals.

10. The method of claim 1, further comprising an indication of a location of the portion in the media content stream.

11. The method of claim 1, further comprising:
receiving a quality measure of a received version of the media content stream, wherein the quality measure is generated in accordance with the signature and the received version of the media content stream; and
adjusting the media content stream based on the quality measure.

12. A communications device comprising:
a portion selector configured to select a portion of a media content stream;
a signature unit coupled to the portion selector, the signature unit configured to process the portion and to generate a signature from the processed portion; and
a transmitter coupled to the signature unit, the transmitter configured to transmit the signature and the media content stream.

13. The communications device of claim 12, wherein the portion selector is further configured to produce an indication of a location of the portion in the media content stream.

14. The communications device of claim 12, wherein the signature unit processes the portion by scaling, reducing a bit-depth of the portion, reducing a color depth of the portion, reducing a dimension of the portion, compressing the portion, or combinations thereof.

15. The communications device of claim 12, wherein the signature unit generates the signature by applying a transformation unit to the processed portion.

16. The communications device of claim 15, wherein the transformation unit comprises a wavelet filterbank decomposition function, a singular value decomposition function, a discrete cosine transform function, or combinations thereof.

17. The communications device of claim 16, wherein the signature unit selects a statistically significant portion of an output of the transformation unit as the signature.

18. The communications device of claim 12, further comprising a quality processor configured to responsively respond to an instruction or at a specified time to initiate a generation of a signature and a transmission of the generated signature.

19. The communications device of claim 12, further comprising:
a receiver configured to receive a quality report; and
a quality processor configured to adjust the media content stream in accordance with the quality report.

20. A method of communications device operations, the method comprising:
receiving a second media content stream;
receiving a first signature, wherein the first signature is based on a first portion of a first media content stream;
selecting a second portion of the second media content stream, wherein the second portion corresponds to the first portion of the first media content stream;
processing the second portion to produce a processed second portion;
generating a second signature from the processed second portion; and
generating a quality report from the first signature and the second signature.

21. The method of claim 20, wherein processing the second portion comprises processing the second portion using a technique used to process the first portion.

22. The method of claim 20, wherein generating a quality report comprises:
determining a difference between the first signature and the second signature; and
generating an indicator in accordance with the difference.

23. The method of claim 22, wherein generating an indicator comprises providing the difference to a classification function.

24. The method of claim 23, wherein the classification function comprises a Kernel Gaussian Mixture model, Canonical Correlation Analysis model, or a combination thereof.

25. The method of claim 24, wherein the classification function is trained a priori and results of the training is stored for subsequent use in classifying the difference.

26. A communications device comprising:
a receiver configured to receive a second media stream and a first signature, wherein the first signature is based on a first portion of a first media content stream;
a portion selector coupled to the receiver, the portion selector configured to select a second portion of the second media stream, wherein the second portion corresponds to the first portion of the first media content stream;
a signature unit coupled to the portion selector, the signature unit configured to process the second portion and to generate a second signature from the processed second portion; and
a quality generator coupled to the signature unit, the quality generator configured to generate a quality report based on the first signature and the second signature.

27. The communications device of claim 26, wherein the quality generator is configured to determine a difference between the first signature and the second signature and to generate an indicator in accordance with the difference.

28. The communications device of claim 27, wherein the quality generator generates the indicator by providing the difference to a classification function.

29. The communications device of claim 28, wherein the classification function comprises a Kernel Gaussian Mixture model, Canonical Correlation Analysis model, or a combination thereof.

30. The communications device of claim 29, wherein the classification function makes use of training data stored in a memory of the communications device.
